(19) United States
(12) Patent Application Publication
(10) Pub. No.: US 2005/0193397 A1
(43) Pub. Date: Sep. 1, 2005

(54) Audio/video transfer and storage

(76) Inventors: Jean-Luc Corenthin, San Francisco, CA (US); Daniel A. Labute, Tmr (CA); Robert M. Keske, Beaconsfield (CA)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/108,085

(22) Filed: Apr. 15, 2005

(30) Foreign Application Priority Data
Sep. 12, 1996 (GB) 9619120

(51) Int. Cl. G06F 12/14

(52) U.S. Cl. 719/328

(57) ABSTRACT

A method, apparatus, and article of manufacture provide the ability to share audio/video clips on a network. A clip comprising a collection of formatted frames is stored on a proprietary file system that is hosted by a server. A lightweight application programming interface (API) enables communication with the server, exposes clip information for clips on the proprietary file system through a tree-like hierarchy, and enables a clip to be referred to anywhere on a network independent of underlying storage. In addition, data may be transferred in the background. A background server is coupled to the file system and hosts a background input/output (I/O) plug-in. Further, a background I/O manager receives a request to transfer data and communicates with the plug-in to coordinate the data transfer in the background. Pursuant to the instructions from the manager, the plug-ins transfer the data from the file system to a server(s) in the background.

### CROSS-REFERENCE TO RELATED APPLICATIONS

This application is related to the following co-pending and commonly-assigned patent(s)/patent applications, which patent(s)/applications are incorporated by reference herein:

U.S. Pat. No. 6,404,975 entitled “Video Storage”, by Raju C. Bopardikar and Adrian R. Braine, filed on Apr. 14, 1997, issued on Jun. 11, 2002, which application claims the benefit of U.S. Provisional Patent Application No. 60/015,468, filed on Apr. 15, 1996 and Great Britain Patent Application No. 9619120 filed on Sep. 12, 1996.

### BACKGROUND OF THE INVENTION

1. Field of the Invention

The present invention relates generally to image/video processing systems, and in particular, to a method, apparatus, and article of manufacture for providing an interoperability framework for transferring and storing audio/visual data.

2. Description of the Related Art

Audio and video files, in the form of a plurality of digitized frames, are often very large and consume considerable bandwidth to process. To accommodate such size and bandwidth, prior art systems have developed various proprietary hardware devices. Such hardware devices have limited access capabilities that are proprietary. Prior art proprietary storage in the video/audio environment is often divided into two segments: (1) project and clip libraries (referred to as clip storage); and (2) raw frame storage. Both clip storage and raw frame storage utilize proprietary storage and access methods and have many limitations. For example, the ability to access clip libraries may not be available in operating system environments other than the system used to implement the library. Further, access to clip storage may be slow due to the network file structure utilized. Also, lock access for an entire clip library may be required to access a single clip thereby causing severe performance penalties. These problems may be better understood by describing the prior art architecture and storage methods.

Prior art hardware devices may utilize a series of magnetic high capacity disk drives that are arranged to supply and store image data in parallel across many individual drives at once. Such drives may be configured as a redundant array of inexpensive disks (RAID). Further details of such RAID systems are disclosed in U.S. Pat. No. 6,404,975 entitled “Video Storage”, by Raju C. Bopardikar and Adrian R. Braine, filed on Apr. 14, 1997, issued on Jun. 11, 2002, which application claims priority to U.S. Provisional Patent Application No. 60/015,468, filed on Apr. 15, 1996 and Great Britain Patent Application No. 9619120 filed on Sep. 12, 1996, which patent is incorpared by reference herein.

Such a RAID system is available in the prior art under the trademark “STONE” from the assignee of the present invention. Further, such a RAID system may comprise a fiber channel storage solution that is the underlying subsystem that provides high-performance, real-time playback of non-compressed digital media.

As described above, there are various problems with the prior art solutions. For example, prior art RAID systems may be proprietary and require compliance with particular formatting and communication mechanisms to utilize the systems. In this regard, third party and standard file systems that do not comply with the proprietary format cannot communicate with or utilize the RAID systems. Similarly, systems that are configured to communicate with one proprietary RAID system must be additionally configured to utilize another proprietary or standard file storage subsystem.

In addition, an entire clip or image may be needed when performing an editing operation. In this regard, the entire clip may need to be transferred to/from storage (e.g., on the RAID system). In the prior art, the I/O transfer between or from a storage disk is performed in the foreground while the user waits an unacceptable amount of time. Alternative prior art systems may perform such I/O transfers in the background (e.g., the application offered under the trademark “BACKDRAFT” from the assignee of the present invention). However, such background I/O transfers were not coordinated among multiple applications thereby resulting in conflicts and duplicative transfers.

As described above, prior art video storage is often split into two segments: (1) a project and clip library that includes project settings, setups, editing constructs, effects, and frame ID tag references; and (2) file system storage (e.g., the “STONE” file system) for storing raw frames and maintaining frame ID tags used to define clips.

FIG. 1 illustrates a prior art storage architecture. Three applications are illustrated—Editing, Effects, and Compositing Application(s) 102 (e.g., IFFFS™—see below), Background Renderer 104 (e.g., BURN™ available from the assignee of the present invention), and Digital Color Grading 106 (e.g., LUSTRE™ available from the assignee of the present invention). Each application 102-106 attempts to use the same local storage 108 on the Editing, Effects, and Compositing Application(s)' host machine.

As used herein, the Editing, Effects and Compositing Application(s) 102 may include several applications used in image processing for effects, compositing, editing, and finishing. For example, such applications may include the applications available under the trademarks “INFERNO”, “FLAME”, “FLINT”, “FIRE”, and “SMOKE” (referred to as IFFFS) available from the assignee of the present invention. As used herein, such one or more applications may be referred to as IFFFS 102.

Within IFFFS 102, a data management layer provides a powerful but complicated set of application services designed to handle everything from highly specialized clip metadata to the sharing of clips across a network (e.g., NFS network 116). However, the data management layer within IFFFS 102 needed to read/write clip libraries 110 is only available in the IRIX/LINUX operating system and has not been ported to Windows™ nor can it be easily separated from the IFFFS application 102.

Accordingly, there is no clean method to transfer clip information to/from a Windows™ based computer system (e.g., a system using the NT File System [NTFS] 112) without a cumbersome export step (e.g., through server 114) (or without the need for the data management layer). In this regard, clip library 110 access may be performed via NFS (network file system) 116, which is slow. Frame access (i.e., to raw frame data in a proprietary file system 118) to/from a Windows™ based machine is also performed using NFS 116 (e.g., through server 114). Gigabit ethernet networks, commonly found at client sites, can realistically attain transfer rates in the order of 80 MB/s on a gigabit ethernet network, but are severely hindered by the performance limitations of most NFS implementations. Further, implementation overhead (including the size of the code) through the data management layer is extensive and burdensome.

IFFFS Clip library 110 files are read directly from disk, requiring that remote clients contain the API (Application Programming Interface) necessary to read/parse the entire library 110. Further, all remote applications that access (e.g., a write operation) IFFFS clip libraries 110 must exclusively lock the entire library. Clip libraries 110 can be quite large. Accordingly, this contention creates severe performance penalties when many clients are accessing clip libraries. For example, long delays may be experienced for both console-based applications and for any concurrent remote access from other IFFFS applications 102. In addition, prior art locking mechanisms offer no priority handling, and can be defeated by the user (by deleting the lock file used to prevent concurrent access).

Alternative applications (e.g., MountStone™ available from the assignee of the present invention) may also exist in the prior art to provide a clip exchange protocol. However, such prior art applications are also based on NFS 116 and carry performance penalties similar to those described above.

In view of the above, what is needed is a system that provides direct clip access (without an intermediary transfer step) from a Windows™ client to storage systems (e.g., project clip library 110, proprietary files system 118 and or local disk 108), with a view to opening up multiple storage devices to applications 102-106. In other words, a framework that provides interoperability is needed.

In addition to the above, what is needed is the capability to use standard file systems (instead of proprietary systems) without a loss in performance capabilities. The performance penalties described above are further exasperated when a particular clip or image is needed and must be transferred between or from storage disks. Accordingly, what is also needed is a method for conducting an I/O transfer efficiently and in a coordinated manner.

### SUMMARY OF THE INVENTION

Embodiments of the invention provide the ability for a user to directly access data on a proprietary file system without passing through a device/medium. Such capability is provided through an application programming interface that exposes information in a proprietary file system in a hierarchical tree-like structure. Accordingly, a variety of file systems and applications are interoperable and may communicate easily and clips may be referred to anywhere on a network regardless of the storage system.

Additional embodiments of the invention provide the ability to transfer data between storage disks (or from storage to temporary memory) in the background. A background I/O manager manages the I/O transfer request received from an application and communicates with plug-ins installed on individual servers that host storage systems. The plug-ins act to perform the actual transfer of data from the respective storage systems to one (or multiple) storage devices or temporary memory for use by the system (pursuant to the control and guidance of the manager).

The invention may also provide the ability to use standard storage systems (e.g., NFS) instead of relying on/using a proprietary file system. A protocol may be used to enable communication on standard storage systems in a consistent manner and to import/export data without significantly impacting existing applications that may depend on such proprietary file systems. Further, access to programs and storage systems may be logged to provide monitoring capability.

### BRIEF DESCRIPTION OF THE DRAWINGS

Referring now to the drawings in which like reference numbers represent corresponding parts throughout:

FIG. 1 illustrates a prior art storage architecture;

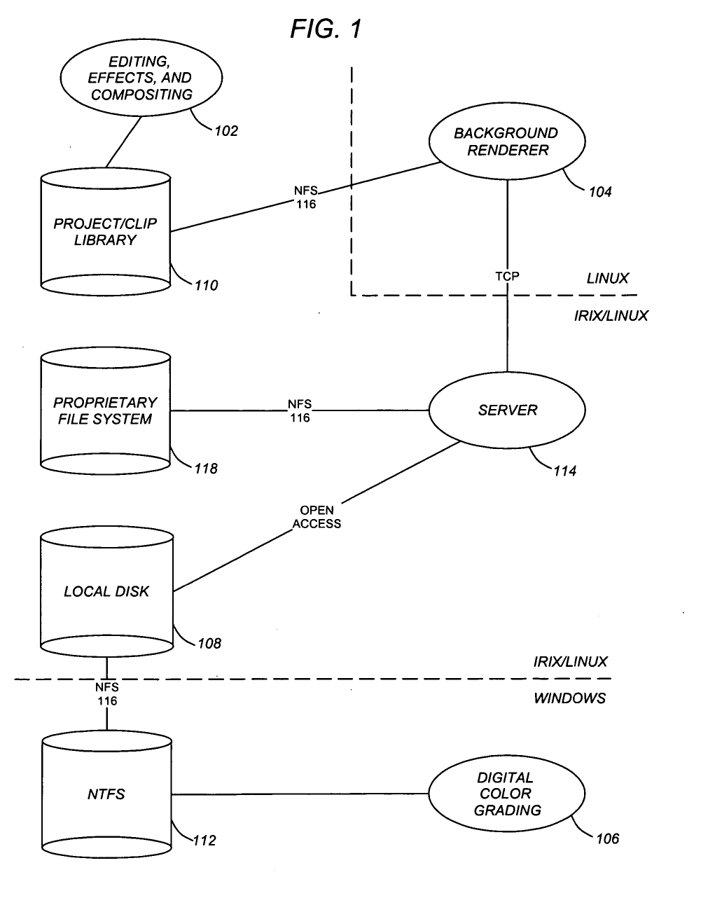

FIG. 2 is an exemplary hardware and software environment used to implement one or more embodiments of the invention;

FIG. 3 illustrates an interoperability architecture in accordance with one or more embodiments of the invention;

FIG. 4 illustrates an internal interface dependency hierarchy in accordance with one or more embodiments of the invention;

FIG. 5 illustrates the architecture used to perform background I/O services in accordance with one or more embodiments of the invention;

FIG. 6 sets forth the logical flow for sharing audio/video clips in accordance with one or more embodiments of the invention; and

FIG. 7 illustrates the logical flow for transferring data in the background in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

As used herein, the term interoperability is defined as a collection of protocols and services that allows for the sharing of audio/video clips and metadata across product, storage, and platform barriers. A clip is a collection of formatted frames. Clip storage refers to the combination of basic clip structure, minimal metadata, and rendered frame content. Further, metadata is attribute and method information describing a variety of application constructs (e.g., effects, setups, etc.) formatted as an XML (extensible markup language) stream.

Hardware Environment

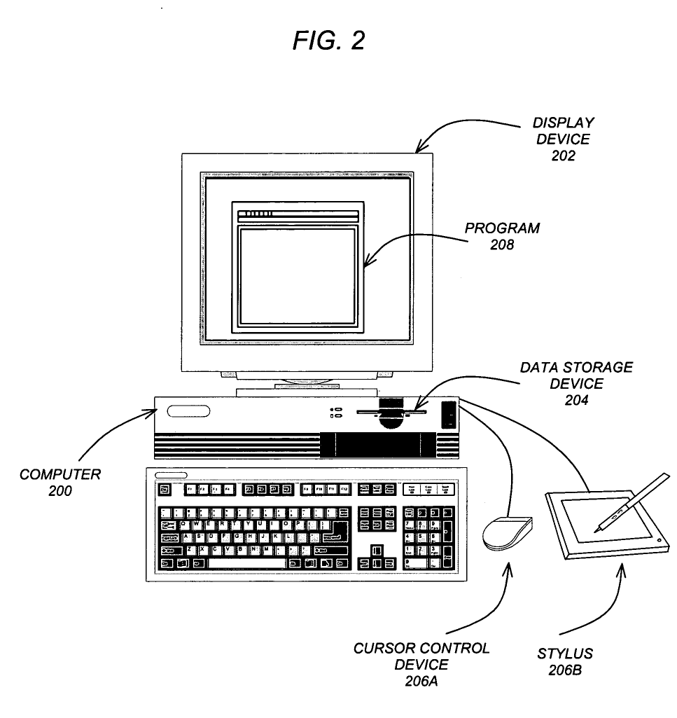

FIG. 2 is an exemplary hardware and software environment used to implement one or more embodiments of the invention. Embodiments of the invention are typically implemented using a computer 200, which generally includes, inter alia, a display device 202, data storage device(s) 204, cursor control devices 206A, stylus 206B, and other devices. Those skilled in the art will recognize that any combination of the above components, or any number of different components, peripherals, and other devices, may be used with the computer 200.

One or more embodiments of the invention are implemented by a computer-implemented program 208. Such a program may be a video editing program, an effects program, compositing application, or any type of program that executes on a computer 200. The program 208 may be represented by a window displayed on the display device 202. Generally, the program 208 comprises logic and/or data embodied in or readable from a device, media, carrier, or signal, e.g., one or more fixed and/or removable data storage devices 204 connected directly or indirectly to the computer 200, one or more remote devices coupled to the computer 200 via a data communications device, etc. In addition, program 208 (or other programs described herein) may be design in an object-oriented program having objects and methods as understood in the art.

Those skilled in the art will recognize that the exemplary environment illustrated in FIG. 2 is not intended to limit the present invention. Indeed, those skilled in the art will recognize that other alternative environments may be used without departing from the scope of the present invention.

Architecture

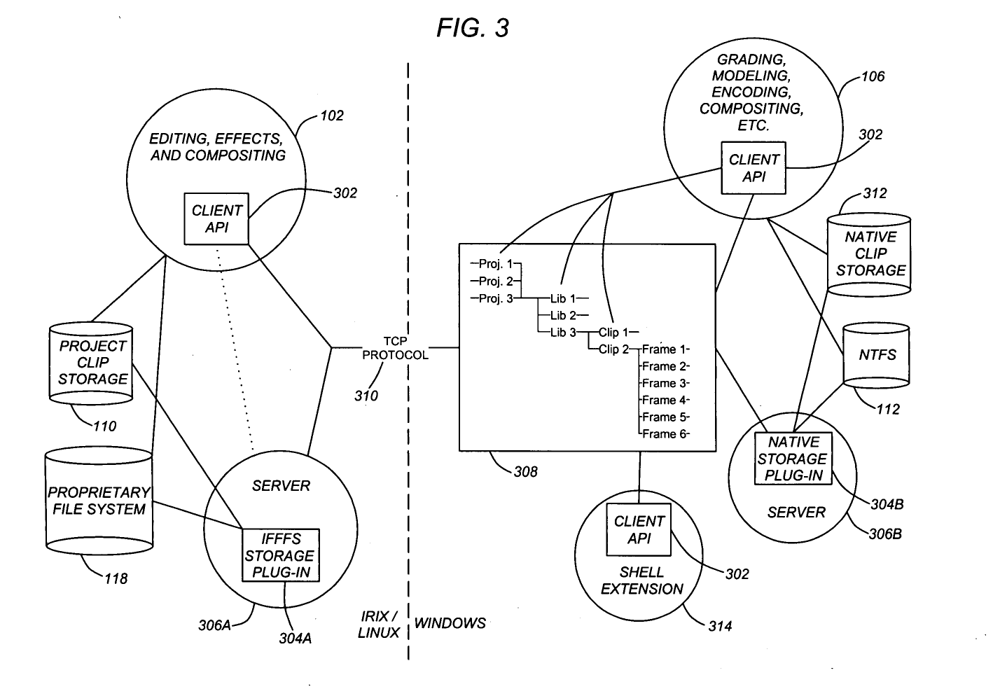

A variety of different operating systems may be used on computer 200. For example, IRIX, Linux, Unix, and/or Windows™ operating systems may also be used on computer 200. Application 208 may be implemented to execute on one or more of such operating systems. As described above, the present invention provides interoperability so that data stored in one operating system environment may be directly accessed from a device executing a different operating system. FIG. 3 illustrates an interoperability architecture in accordance with one or more embodiments of the invention.

The basic architecture is that of a lightweight client API 302 communicating with a server daemon/service (e.g., a plug-in) 304A/304B running on the machine 306 that hosts the storage device 110 to be shared. Interoperability is separated into a clear set of responsibilities/components. In this regard, the architectural design of the invention establishes and isolates responsibilities. The main components that provide interoperability are:
(1) Client/server API specification;
(2) Transport protocol and frame I/O optimization;
(3) Server Application infrastructure and SDK;
(4) Server-side data storage plug-in; and
(5) Metadata specification.

The first three elements may be provided by one aspect of the invention while other applications and groups may focus on the complex tasks of metadata definition and project/clip data representation and storage issues.

As described above, IFFFS clips are stored in clip libraries and projects 110, with frames stored on a proprietary file system 118. Sharing is defined as the ability to read and write clip information and frame data directly to/from native storage. As used herein, a “clip” refers to a collection of frames that exists on a specific addressable framestore. “Frames” are simple RGB buffers formatted as specified by the clip. In this regard, frames may be stored and transferred as raw RGB buffers without a provision for any kind of formatting or compression. Accordingly, the invention may be utilized to support frame formats of any kind (e.g., compressed or otherwise). Prior art methods lacked practical methods for reading/writing clips to/from storage 110/312.

Volumes, projects, reels, clips, tracks, or whatever constructs an application chooses to expose are accessible through a tree like hierarchy 308. In the hierarchy 308, various storage structures (e.g., project, library, clip, etc.) are exposed as nodes. Any node in the hierarchy 308 may be represented using an XML (extensible markup language) metadata stream. Further, metadata hooks may be provided at the node level of the hierarchy 308. Such metadata hooks allow access to metadata at each node level. However, the present invention may limit the types of metadata available. Nonetheless, the API 302 may be expanded to allow servers to publish metadata details of a clip, library, project, effect, etc. via XML, AAF, or any other metadata format. Accordingly, the hierarchy 308 and design provides clear access points to facilitate metadata exchange between applications. The metadata granularity desired is left up to the client API 302.

The basic structure of the hierarchy 308 may be communicated between the APIs 302 and servers 306A/306B using a particular TCP (transmission control protocol) protocol 310 (see detailed description below). Through the protocol 310 and other elements depicted in FIG. 3, complex application storage hierarchies can be presented in an intuitive and easily extendable fashion.

As illustrated in FIG. 3, native clip storage 312 is exposed as a simplified tree 308, allowing for easy navigation in a familiar layout. It is up to the storage specific server 306A/306B (and the plug-ins 304A/304B) to decide how the server 306A/306B will expose the structure of the clip 110/312. The interface presented to a user may be specific to the application that deploys the API 302. While the tree structure 308 may expose limited data (e.g., audio/video tracks may not be exposed), the tree structure may be easily extended to include such information/data. Such an extension may be implemented via XML or AAF metadata extension.

The Client APIs 302 include methods for transferring frames across the TCP network 310, thereby providing optimal performance. The API 302 layer is deliberately specified on both the client and server side of the framework so as to provide dual-end optimizations at both the frame I/O and data storage levels. Such a placement and utilization of APIs 302 provides for clip sharing over TCP/IP 310 while eliminating the need for NFS. Without requiring NFS, deployment and maintenance on client sites may be facilitated. In addition, by managing all connectivity at the TCP level (as opposed to the NFS level), performance can be optimized specifically for frame and clip I/O.

The ability to provide remote clip sharing without NFS is distinctly different from the prior art wherein remote clients were required to use two communication protocols to have access to clip servers: NFS to read/write clip library information, and TCP/IP to read/write frames. It is also noted that NFS configurations are generally slow and difficult to maintain. However, the present invention does not require NFS to achieve clip sharing. In addition, without the need for NFS, the present invention does not need to maintain parallel network connectivity mappings (NFS, TCP, etc.).

By installing an API 302 between the client application 102/106 and the underlying storage 110/312, a defined abstraction layer allows the user to switch between underlying storage (remote or local). Accordingly, a clip may be referred to anywhere on a network independent of its underlying storage (referred to as “any clip anywhere”). In other words, regardless of where on a network a clip is located, the clip is viewed as if it were a local frame. Such access capability avoids prior art costly frame/clip wire transfers. Further, to process frames transferred in a package, the frames will be unpacked before being passed on to the client API 302.

In view of the above, the client APIs 302 may be viewed as a lightweight library. In this regard, the client APIs 302 are thread-safe and will not create their own threads or allocate significant amounts of memory (e.g., for frames). The client APIs 302 depend only on the most basic operating system services and are designed not to have any significant design or dependency impact on any targeted application architectures. For example, in a Windows™ platform, the client API 302 may be provided via a Windows Explorer™ Shell extension 314, which exposes the hierarchy 308 in an Explorer™-like interface commonly used by Windows™-based applications. In addition, the client API 302 may be embeddable in a variety of products. Such embedding would support inclusion/linkage into applications having the embed client API 302. In such an embodiment, no restrictions based on memory management, threading model or any other architectural constraint may exist by virtue of the simplicity of the client API 302 library and functionality.

The client API 302 must be able to read clips and frames. If the client desires to read the frame directly (e.g., from proprietary file system 118), the client API 302 may have embedded code enabling such access. If the client API 302 has such embedded code, the client API 302 must be ported for Windows™ clients. However, if the client access the frames through server 306A/306B, then the code does not need to be embedded in the client API 302.

The client API 302 enables the direct access to frame and clip storage across TCP connection 310. The protocol set forth below defines the format and content for the purpose of a simple clip information exchange. In this regard, sophisticated metadata (e.g., AAF—Advanced Authoring Format) may not be defined. Instead, just essential information needed to convey clip name and format, library 110 location (machine/path), and storage specific frame IDs may be enabled. The information used in the protocol may be just enough to allow applications 102 and 106 to share clip information.

Public APIs

Features are exposed to the client via a set of public APIs (e.g., client API 302). These public APIs 302 enable the ability to access data stored in a proprietary format from non-proprietary systems/products. The non-proprietary system merely needs to implement the API 302 to enable the ability to get/retrieve address information and write data directly from/into the proprietary hardware.

Client API

The Client API 302 is the interface layer exposed to remote clients. As described above, the client API 302 is a lightweight library with a simple unified interface to a small set of utility functions. The API 302 may be required to provide the following:
Allow machine and clip hierarchy browsing and clip creation.
Allow high performance frame read, and new clip creation.
Encapsulation of all TCP 310 connectivity and optimization.
Full error handling with appropriate error message hooks.
Transaction processing and unrolling to properly handle mid-stream errors during clip writes.
Windows™, LINUX, and IRIX versions of the library.

In addition, the API 302 may be exposed using a Windows™ shell extension 314. Such exposure would enable the sharing of proprietary storage across all Windows™ products that can interpret a clip as a directory of image files. Alternatively, the API 302 may remain private for particular products (e.g., products offered by the proprietary storage owner, sister applications, and/or selected 3rd party vendors).

Server API

The Server API is the interface layer exposed to a locally running server 306A/306B, and is essential to the creation of a storage-specific server daemon for IFFFS 102. Such an API may be required to provide the following:
Simple API hooks to implement a native clip storage server 306B.
Encapsulation of all TCP connectivity and optimization.
Full error handling with appropriate error message hooks.
Adaptable application framework to interface with existing clip storage libraries.
IRIX and linux versions of the library
   Protocol

As described above, the APIs 302 communicate via the TCP protocol 310. The protocol 310 defines the format and content of shared clip information. Further, the protocol 310 is a list of methods conveyed according to a strict internal ASCII format, all of which is encapsulated in an API utility layer.

Various terms and information may be utilized by/with the protocol 310 including:

Node—an element of the hierarchy optionally containing child nodes.

Clip—a collection of frames of a single specified format.

Clip Node—specialization of the Node object for accessing clips.

Clip Path—the full unique path (machine/directory) to the specified clip.

Format—the storage format of the frames of a clip.

Frame—a single image of a clip.

Method—a specific function of a Server 306A/306B.

Host name—Unique name chosen to identify the Server 306A/306B (i.e framestore name).

The protocol 310 establishes the ability for remote communication. A TCP command, defined by an extendable protocol 310, may be sent to a daemon. The protocol 310 defines the API 302 for creating a remote command, the ASCII protocol for TCP transmission, and the API for unpacking and executing the command when received by the server 306A/306B. The ASCII TCP protocol may provide information about a command including whether the command is synchronous, asynchronous, and/or requires a response. Further information may identify a specific object, a function name, and a parameter list.

To enable remote communication, the ASCII TCP protocol may have a wrapper in the form of a remote control API (rcAPI) that facilitates transmission encoding and decoding of the ASCII stream to/from data structures. The API 302 provides the ability to define and register a remote control method that can be invoked and processed using a TCP protocol 310. The API 302 automatically formats command and escapes out any illegal characters (e.g., space, newline).

A specific clip transaction is a lengthy list of operations that can fail for various reasons. To accommodate such failure, the API 302 provides for the cleanup and unrolling of partial transactions thereby allowing clients to write more robust code. In addition, while the server 306A/306B defines the format of the frame ID (e.g., 64 bit long, path to image file, etc.), the format may not be exposed to the client. In this regard, the client may simply ask for frames by index from an instantiated clip object.

Internal Architecture and Server SDK

The Server 306A/306B is a standalone daemon (no UI) that provides a basic application infrastructure and a simple function registration mechanism to allow for the creation of a storage-specific server plug-in (e.g., plug-in 304A/304B) through an SDK.

The SDK is simply a list of services publicized as a class with publicly declared unimplemented function calls. These functions must be implemented by the plug-in to provide basic services.

Internal Services

Internally, functionality may be divided into three separate services:
Base—Essential connectivity services, ping, capabilities, versioning, etc.
Frame—Provides read/write frame access.
Node—Node-level hierarchy manipulation for clips, projects, libraries, etc.

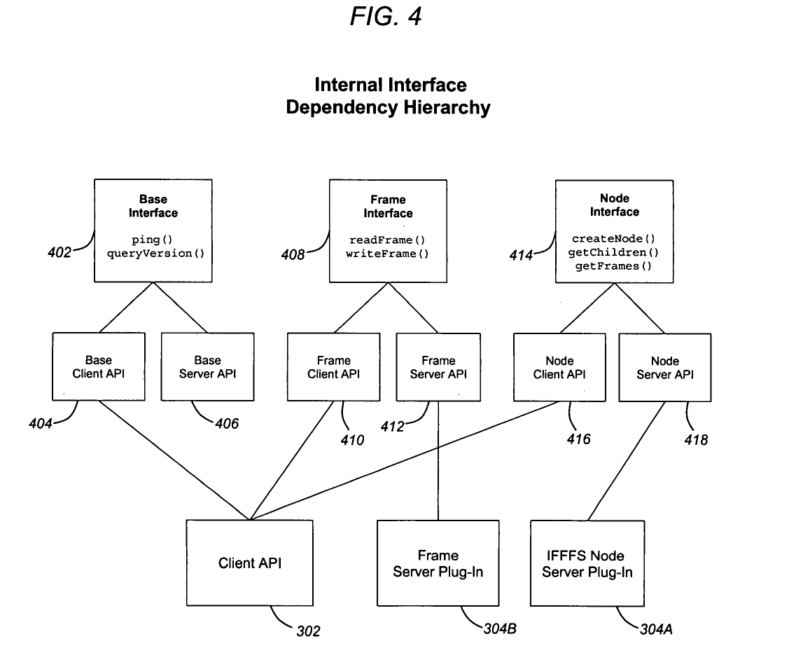

This separation exists in order to isolate and facilitate the implementation and abstraction of each component/function of the server 306A/306B. FIG. 4 illustrates such a separation in the form of an internal interface dependency hierarchy in accordance with one or more embodiments of the invention.

Base interface 402 maintains the ability to ping a computer (e.g., server 306A/306B) across a network and determine a version of a server 306A/306B. As indicated in FIG. 4, the base interface 402 may be implemented via a base client API 404 or base server API 406.

Frame interface 408 is configured to read/write a frame into a supplied buffer. The frame interface 408 may be implemented by a frame client API 410 or frame server API 412. While the frame interface may be implemented to read/write a frame to a buffer, frames may also have identification requirements in that the implementation of a frame on the server-side may vary from system to system. For example, a frame may be identified by a frame ID or a path to an image file on a NAS. Accordingly, a data structure may be used to house a frame identification tag. The frame identification tag may be used by clients to identify the frame and the client may store the tag in its own persistent data structures for subsequent access.

Node interface 414 provides the ability to work with and edit nodes in hierarchy 308. For example, node interface 414 may be implemented to create/destroy a node, identify the number of child nodes, identify the type of a specified node, allocate frames for a clip object specified in a particular format, obtain a list of frames for a specified clip node, and/or identify a format of a specified clip node. Node interface 414 may be implemented by a node client API 416 or a node server API 418.

While the node interface 414 provides the ability to work with nodes in hierarchy 308, node identification is specific to a storage implementation. For example, nodes may be represented internally as unique keys, or paths to library files.

The client needs to manipulate these nodes without being aware of the underlying implementation of the server 306A/306B. Accordingly, a data structure may be used to house a node identification tag that is specific to the implementation of the server plug-in 304A/304B, is persistent, and is unique to the particular machine/database.

Clients may manipulate all nodes via the data structure, which will have been constructed by the server 306A/306B. Accordingly, clients may never need to construct their own node identification objects. Instead, the client may store the ID tag in its own persistent data structures for subsequent access.

Clip Format Specification

The invention offers basic services to read/write a clip's frames. In order to interpret the raw frame data, the client needs a minimal set of information relating to the formatting of the clip. An established method and structure (e.g., in the form of an object oriented class) may be utilized to exchange this information. Such a class may not cover all clip formatting metadata, but rather just enough to perform basic frame manipulation and clip playback. For example, various methods may return properties of the clip such as the height/width of a clip, the number of bits per pixel, the frame rate, the pixel ratio, the encoding format of the frame data, if any, and the frame buffer size. The class may also enable the ability to set the various properties.

In one or more embodiments of the invention, all video frames may be raw RGB, by default. Audio frames on the other hand, may need to know the encoding format (e.g. AIFF) in order to interpret the data stream. In alternative embodiments, formatted frames (e.g. tiff, jpeg, etc) may also be supported.

Path Translation Services

As described above, a network may involve multiple operating systems (OS). However, the prior art presents problems with respect to translating file paths between stations in a multi-OS network. For example, a digital color grading application 106 may desire to use a clip exposed by a remote editing, effects, and compositing application 102 running on IRIX. With proprietary frames 118, the data can only be accessed by the remote server 114. As described above, a frame API may be used to read/write the frames over a TCP connection.

If the remote clip is a soft-imported clip (e.g., Open Access), the clip is merely a set of filenames on some shared storage device. In such a situation, the digital color grading application 106 may not use the frame API to read the frames, but rather accesses the frame files “directly” using the fastest available data path from the application 106 to the shared storage device. However, the problem is that the application 106 (e.g., running on Windows NT), may not map/mount a shared storage device using the exact same path specification as would a remote IFFFS 102 station (e.g., running on IRIX). For example, the IFFFS 102 might store a reference to a frame on a storage area network (SAN) using the following path:
/CXFS/myclips/clip1/frame1.dpx

However, the digital color grading application 106 may have mapped the SAN onto drive N. Thus, the path to the very same file seen from a Windows™ station is:
N:\myclips\clip1\frame1.dpx

Of particular note are the differences between the two paths: the drive letter prefix, the omission of the CXFS mount point name, as well as the path separator character differences. The problem with the prior art exists with performing the path translation. The prior art fails to provide any path translation other than having each host application (e.g., digital color grading 106 or other applications) provide the path mapping rules for paths retrieved from remote stations.

To overcome the disadvantages of the prior art, embodiments of the invention may utilize a protocol as described above. The protocol has a mechanism to return the frame file paths (instead of frame IDs) of a given clip, allowing the remote application to use direct network paths to access the media. To enable remote clients to read frame paths retrieved from a remote server without first messaging the paths, the protocol may also provide a path translation mechanism.

A server 306 can easily perform this translation when accepting or returning file paths of any kind. Accordingly, no changes would be needed to the existing client API 302 or server plug-ins 304. However, the server 306 may need to know how to translate a path from one station to another.

Path Translation Database Specification

Considering the complexities of heterogeneous (i.e. mixed OS) networks, there is no easy way to automate the creation of a “database” of path translation rules. This database will need to be maintained by hand as new hardware is added/removed, and as network topology is changed.

The fundamental translation operation may utilize the following input:
Source file path (e.g./CXFS/myclips/clip1/frame1.dpx);
Source hostname or IP address (e.g. tanzania);
Source OS (e.g. IRIX);
Destination hostname or IP address (e.g. 192.1.1.45); and
Destination OS (e.g. NT).

As output, the translated file (that provides optimal performance when accessed from the destination host) is returned. The translation database must be populated and maintained by the system administrator, who is typically aware of the network topology and installed hardware in a given network.

Path Mapping Database Syntax

The translation database is a set of mappings (in XML format) that specify how to perform a path translation given the input parameters above. The XML stream is stored in a configuration file as part of a server 306 daemon installation. This configuration file can be centrally located on a network such that all server 306 daemons can access it on startup.

Each mapping is an instance of one of the three rules—Host/Path Rule, Grouping, and Platform Rule:

Host/Path Rule

The host/path rule allows a single source host/path pair to be associated to a single destination host/path pair. This is a point-to-point configuration.

```
<map src_host=”...” src_path=”...”
    dst_host=”...” dst_path=”...” />
e.g. <map src_host=”tanzania”
src_path=”/CXFS/myclips”
        dst_host=”192.1.1.45” dst_path=”N:\myclips”
/>
```

The host/path rule identifies how a path should be translated between two specified hosts. All other rules can be written in terms of host/path rules. In practice, however, using host rules is impractical, as every combination of client/server will require a rule.

As per XML formatting standards, the values assigned to the four parameters may not be permitted to include ampersands (&) or left angle brackets (<) in their literal forms. All instances of these characters should be replaced with &amp; and &lt; respectively. The white-space between the attributes is ignored.

Grouping Rule

In larger installations, system administrators are more likely to standardize the drive letters used to mount remote filesystems. Hosts are usually grouped in some manner. The group rule provides a way to define named groups of hosts as follows:

| <group name=”...”> [<host name=”...” />] </group> | |
|---|---|
| e.g. | <group name=”BurnRenderFarm”> |
| | <host name=”burn1”/> |
| | <host name=”burn2”/> |
| | <host name=”burn3”/> |
| | <host name=”burn4”/> |
| | <host name=”burn5”/> |
| | </group> |
| | <group name=”LustreStations”> |
| | <host name=”lus1” /> |
| | <host name=”lus2” /> |
| | </group> |

Once defined, groups can be used in place of hosts using the same syntax as the host/path rule. Either the src_host, dst_host or both can specify a group. Note that group names and host names must be unique. The following example shows how groups can be used:

| | |
|---|---|
| e.g. | <map src_host=”LustreStations” |
| | src_path=”N:\myclips” |
| | dst_host=”BurnRenderFarm” |
| | dst_path=”/CXFS/clips” /> |

This rule covers paths emanating from a host in the LustreStations group being translated to a host in the BurnRenderFarm group. In this manner, adding a new render farm node will only require the addition of the node to the group, rather than creating a separate rule for all permutations of hosts using the host/path rule.

Platform Rule

The platform rule is similar to the group rule in that the rule is applied to a set of hosts that have the same operating system:

| <map src_os=”...” src_path=”...” | | |
|---|---|---|
| dst_os=”...” dst_path=”...” /> | | |
| e.g. | <map src_os=”Irix” | src_path=”/CXFS” |
| | dst_os=”WindowsNT” | dst_path=”N:\” /> |

On a network where all Windows stations mount a central storage device to the N: drive, this rule would be a simple way to express the translation and facilitate the addition of new hardware to the network.

The src_os and dst_os attributes may be restricted to the following values:
Irix
Linux
WindowsNT
MacOSX.

Rule Resolution

The above rules may be applied in the order they are presented, the first rule entered being the one that takes precedence. If multiple mappings apply, the mapping which matches the most characters in the source file path will be used. If the mapping's source path is only a prefix for the path being translated, the unmatched characters will be appended to end of the destination path.

Sharing the Path Database Across Servers

The path database may be stored as an XML file, which must be accessible to all servers 306. Keeping redundant copies of the file on the network will improve reliability at boot up time, but will be more difficult to maintain as the network topology changes. To give system administrators the ability to balance reliability and maintainability, the server 306 will load a local file that can either contain the database itself, or be a symbolic link to a remote centrally located version.

The path to this file on Linux and IRUX installations of a server application (e.g., server application 114) is:
/usr/discreet/sw/cfg/sw_wiretap_path_translation_db.xml

The servers 306 periodically check the timestamp of this file and update themselves accordingly. Upgrading an installation of a server 114 will preserve this file (or symlink), but a new/fresh installation may install the default database. Therefore, all fresh installations may require the relinking/resetting of the file to the desired contents.

Client/Server API 302 Functionality

Although most path translation operations are done implicitly within an interoperability framework, there are many situations when the client and server 306 will need to perform manual translations. The API 302 will therefore provide calls to perform path translations. On the server side, the calls will simply query the local path database as loaded from the rule file specified above. Server-side calls are required when generating metadata (e.g. EDL [edit decision list]) that contains file path information.

The client API 302 may differ in that the remote station (e.g. digital color grading application 106 on NT) has no local server 114, and will likely not have direct access to the rule file. In addition, it may be useful to avoid identifying a particular server as being “the” path translator (akin to a DNS server) because to maintain some redundancy in the network if the remote server is down.

Accordingly, existing multicast services may be used to allow a client API 302 to find the “first” server and ask it to perform the path translation. Further, the client API 302 may ask for the applicable rule, and cache it locally to avoid needless network traffic when translating large sets of paths.

In addition, functionality may differ with the updating of the client API's cache when the rule database changes. In this regard, rather than updating the remote API, the client program (e.g. a digital color grading application 106) may be forced to restart when the database changes. Given the low frequency of rule database changes, and the relatively short lifespan on a client application, such a restart will not have a large performance impact.

Background I/O Services

As described above, data is often transferred from storage to memory (e.g., in one or more servers) for use by multiple applications. For example, an application may desire to perform a rendering operation that requires information (e.g., frames and clips) stored on proprietary hardware or a disk. To render the images, the information must be transferred from the disk to memory (e.g., a buffer in a server). Accordingly, an application from multiple clients may issue a render request for particular data to one or more nodes (that contain the data) in a system. However, such information may be extremely large and may be time consuming to transfer. In the prior art, such transfers occurred in the foreground forcing the user to wait an unacceptable amount of time. In addition, some prior art methods allowed transfers to occur in the background. However, such prior art mechanisms were not automated and required manual configuring and instructions to perform the transfer.

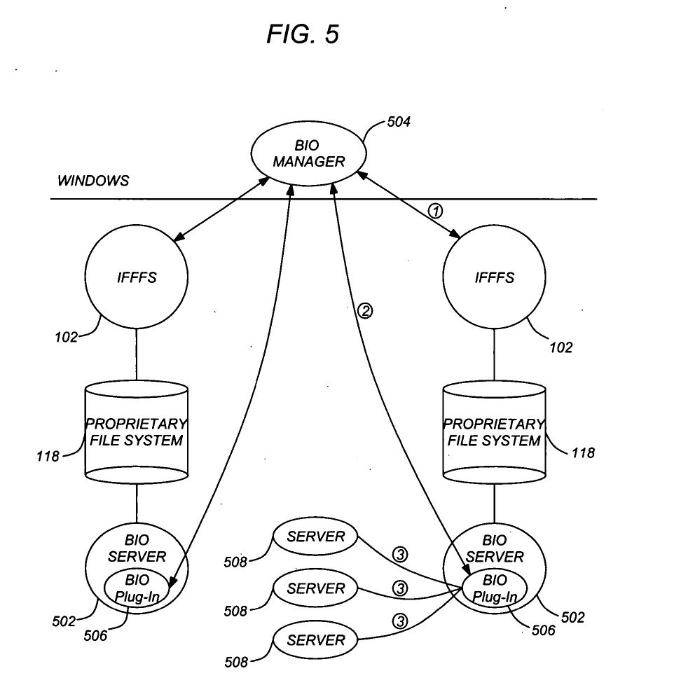

The present invention provides the ability to perform background I/O operations in an efficient and automated manner. FIG. 5 illustrates the architecture used to perform background I/O services in accordance with one or more embodiments of the invention. As illustrated, each machine (i.e., that hosts a IFFFS application 102 and proprietary file system 118) has a background I/O server 502. Further, a background I/O manager 504 communicates with the servers 502 and controls the transfer of data. More specifically, the BIO manager 504 communicates with background I/O plug-ins 506 installed in each BIO server 502. The plug-ins 506 are dynamic shared objects (DSO) that may be shipped with proprietary hardware systems, that are installed along with BIO servers 502 on a host IFFFS 102 station. The plug-in 506 simply sends requests to the locally running server daemon.

As illustrated in FIG. 5, the first step is that of IFFFS application 102 desiring to move/transfer data from storage to memory in a server 508. Accordingly, IFFFS application 102 transmits a request to transfer data to the BIO manager 504. A small client API may be used to launch the request. Such an API would encapsulate job submission parameters and a connection to the BIO manager 504.

The BIO manager 504 then communicates with one or more BIO plug-ins 506 on BIO servers 502 to coordinate the transfer. The BIO plug-ins 506 then transfer the data to multiple servers 508 (e.g., that are managing proprietary storage/file systems 118) (or another BIO server 502). Such transferring occurs in the background on an automated basis without the need for a client to individually control or manage the transfer of the data. Further, multiple servers 508 may receive the data in the background. Alternatively, the BIO plug-ins 506 may transfer the data to alternate/temporary storage devices (e.g., from proprietary storage 118 to floppy discs or CDROM) in the background. Such transfers relieve the load on single proprietary file systems 118 from requests from multiple applications for data. Instead, the BIO manager 504 manages the transfer through coordination with the BIO plug-ins 506.

To further enable the background I/O transfers, the BIO manager 504 may provide a job monitor that monitors and controls background I/O jobs. Such job monitoring and control may be available from IFFFS application 102. For example, an I/O status window may be connected to an API within IFFFS 102 that allows a client to monitor and control background I/O operations.

Non-Proprietary Storage

Most prior art systems are configured to exclusively use proprietary storage that accommodated the unique nature of audio/video data and applications. As storage capabilities increase, the need for such proprietary storage has decreased. However, many applications are configured to execute using such proprietary storage. Rewriting such applications to accommodate new standard storage facilities is a difficult task.

The present invention allows the ability for advanced systems software to run exclusively on a standard file system. In this regard, the invention maintains the ability to read and write video frames as regular files in various formats (e.g., dpx, tiff, jpg, sgi, etc.), all of which have their image information, or resolution, stored in the files themselves. Additionally, embodiments of the invention may also permit the use of proprietary storage. In this regard, the invention provides a solution where the application behaves the same regardless of the nature of the framestore: same calls, same code path. In other words, a layer above the client API 302 remains oblivious to the nature of the framestore.

To enable the use of non-proprietary storage, a frame ID abstraction provided by the API 302 is the universal means to access a file, audio or video, on the framestore. A frame ID is a 64-bit value, composed of bit fields whose role is to identify its storage location (which framestore) and storage nature (whether standard or proprietary). With proprietary framestores, frame IDs may be stored directly in a descriptor table as an unsigned 64-bit integer. Under standard framestores, frame IDs may be implemented by symbolic links points to the image files. Symbolic links are named after the string representation of the frame ID in hexadecimal (e.g., “0xf9c000018ec0656c”).

Frames may also be unmanaged in storage. For example, a reference count of users of the file may be not maintained. Accordingly, files may not be deleted even when there is no user anymore. Since a client application (e.g., IFFFS 102) does not own such files, it cannot be decided if they can be discarded as they may be used as sources by other applications. Nonetheless, cleanup may be performed by removing the frame IDs (links) when no clip refers to them anymore (e.g., by a project-aware volume integrity check).

Alternatively, frames generated by a client application (e.g., IFFFS 102) during editing or compositing may be generated for the client application's own use. In order not to pollute the framestore with obsolete files, management may be useful. For example, frames may be frequently invalidated by new processing. Such invalid frames may be removed when no longer referenced by any clip. In addition, one or more unused bits of a standard frame's frame ID may be used to identify whether the frame is managed or unmanaged.

Frame Access

To access a frame, an application first examines the frame ID to determine if the frame is local or remote. If the frame is remote, the request is given to a network I/O thread that sends the request to the appropriate remote server 306A/306B. If the frame is local, the application may handle the request directly.

The application then examines the frame store type to determine if the frame is stored in proprietary storage or standard storage. If proprietary, the frame ID is given to a proprietary driver that returns the address on the disks. For standard frames, the frame ID is translated into its ASCII representation and a path to the soft link may be built such that when resolved, the path to the actual file is obtained.

To optimize performance, an image file format that matches the format used internally by an application may be selected or used as a default destination file format (e.g., RGB). Accordingly, proprietary storage may require the addition of support for RGB. However, a drawback for using raw format is that the image resolution is not stored in the file. Such information, called frame information, is required to interpret the data. The frame information (or frame format) comprises all data necessary to interpret the content of a frame. In the case of an image, the frame information comprises the resolution, bid depth, and endianness. In the case of an audio file, it is the sampling frequency and number of bytes per sample. Other types of frames, if any, would have their own type of frame information. In addition, the frame information may be stored in an ASCII file in a collection directory. Such a Frame Information file (e.g., containing ASCII data) may be stored alongside with the frames when an allocation is performed. In addition, as the need arises, the user may be given the option to choose the destination format for managed frames. Such a choice may be available via a client API 302.

When an application desired to create a new frame, it first sends an allocation request (e.g., for a particular number/collection of frames) to a server 306A/306B. For proprietary storage, some space for the frame may be reserved on the framestore thereby allowing for the return of a frame ID to the application (in response to the allocation request). For standard storage, a symbolic link to an image file may be created and a frame ID is returned. The file is then created immediately by touching the file, but the content may be written later, when the application performs the write request.

The allocation request may be directed towards a particular number of frames. A collection of frames is a group of frames allocated within the same request. Accordingly, frames allocated in a collection must share the same properties. At the application level, frames are typically contained in a media object, which are used to compose clips as a container of media objects. For each collection of managed frames, the server 306A/306B may create a director, a collection, in a Frame Pool which provides the location where the files will actually be created later. The name of the collection may then be generated and returned to the application. Unmanaged frames may exist outside of the Frame Pool.

As indicated above, managed standard frames may need to be reference counted. In proprietary framestores, the actual number of users of a frame may be maintained in a frame descriptor table. Further, proprietary frames are allocated with a reference count of 1 that is incremented whenever a frame is reused in a different application library. This is under the control of the application. Under standard framestores, hard links to a file, one per user, may be stored/maintained by the operating system. Unmanaged standard frames are not reference counted and thus, no hard links will ever be created pointing to them.

When allocating frames, a server 306A/306B may automatically create a hard link to files in a Reference Pool, to parallel a proprietary scheme where a frame starts with a reference count of one. Whenever an application needs to reuse a given frame in another clip, the application would use a new API 302 call to create a reference to it. Upon calling the function, a new hard link may be created to the file represented by the frame ID, in the Reference Pool director corresponding to the given collection tag.

In a traditional model, a volume (i.e., a logical view of a framestore partition with associated clip metadata) in its entirety may need to be periodically checked to ensure its integrity between frame usage and frame reference count. In a model in accordance with the invention, the integrity may be checked on a media basis. For example, a collection for a media file may be found or created. For each frame of media in the collection, a link in a Frame Pool (corresponding to the frameID) may be found and compared to a hardlink for the frames (i.e., stored in a directory containing the collection). If a hardlink does not exist, one is created. Such a comparison ensures integrity between frame usage and the frame reference count.

Access Log

One or more embodiments of the invention also provide an infrastructure for global error messaging and notification that includes the logging of access to programs and storage systems. Specifically, for each application, a log file may be stored in a directory specified by the application. Each time a program (e.g., IFFFS 102) is run, a new log file may be created. Old log files may be archived with the application determining how many logs will be maintained before being overwritten. Further, a naming system may be adopted that clearly identifies the log file. Accordingly, a directory listing may be used to quickly view the history of calls to a particular program. In addition, log files may be rotated when a maximum size specified by the application (e.g., 500 MB by default) has been reached.

However, some command-line programs (i.e., test programs and utilities) may not create log files. Instead, logs may be output directly to a shell. By default, logs printed to the shell may not be formatted (i.e., contain only the message itself) for readability purposes.

Log files may follow a particular format. For example, log files may have a header followed by a one log entry per line. The header format may be constant across all applications, and can be modified to contain extra information common to a particular set/suite of applications. A line with a leading number may be used for a comment line, or the header block.

Each line (i.e., log entry) is a series of space-separated fields. The following parseable format may be used in a logging system:
Message Level: user|error|warn notice|debug.
Process ID: Notice that processes are registered so that a correspondence can be made to each log entry.
Source code file and line number where message was issued. (Path to source not specified for security purposes.)
Time elapsed (in seconds) since the start of the application. Times are based on the hardware timer.
Message: All messages must exist on a single line. In a multi-threaded application, messages can be intertwined with each other. The asynchronous logger will guarantee that the logging of each message is serialized and atomic, but may not guarantee atomicity across multiple entries.

In addition to the above, environment variables may be used to control logging at a high level. For example, a message level variable may be used to control the filtering of messages issued by an application. Only messages of a level equal or greater to the one specified may be logged. A verbose variable may be used to produce verbose output formatted exactly like a log file rather than only containing the actual message and not extra debugging information (e.g., when a log is printed to a shell). An echo to shell variable may echo all logs to a shell when asynchronous logging is deployed in an application. In this regard, formatting may be subject to the verbosity setting in the verbose variable.

Message levels may be defined for logging purposes. For example, the following levels (in order of decreasing priority) illustrate examples of the various levels that may be available: a user level may denote an important successful operation (e.g., “setup loaded successfully); an error level denotes a failed operation (e.g., an operation was halted in mid-stream such as out of memory or cannot delete file); a warn level may denote an operation that completes with non-fatal errors. Warnings may be viewed on-demand by the end-user or integrator in a log viewer but may not necessarily be displayed in a user interface; a notice level may denote a successful operation or an operation that completes with minor faults or caveats (e.g., a connection was successful on a particular port); a debug level may be used by developers and integrators to aid in tracking down bugs in house or on-site. However, care should be taken so as not to pollute the debug message space with non-essential messages that only a single developer will understand. Debugging traces (e.g., printing a pointer) or verbose traces may not be emitted with the debug level without conditional compilation preprocessor macros or environment variables in place to prevent log file pollution.

Logical Flow

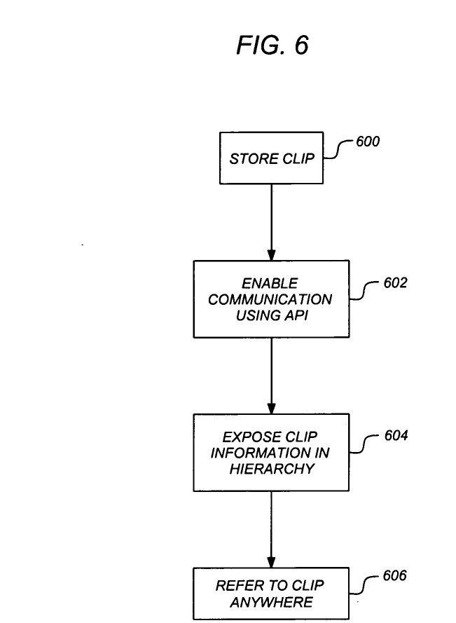

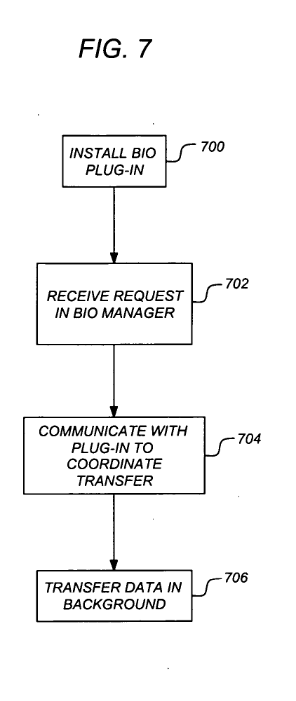

The above description sets forth the various architectural design features used for implementing the invention. FIGS. 6 and 7 set forth the logical flow for implementing a method in accordance with one or more embodiments of the invention.

FIG. 6 sets forth the logical flow for sharing audio/video clips. At step 600 a clip is stored. As described above, the clip comprises a collection of formatted frames on a proprietary file system hosted by a server. At step 602, communication with the server is enabled through a lightweight application programming interface (API). The lightweight API/library comprises a simple unified interface to a small set of utility functions. In addition, the API utilizes a protocol to enable communication across the network for remote communication.

Accordingly, at step 604, the API exposes clip information for clips on the proprietary file system through a tree-like hierarchy. Storage structures on the proprietary file system may be exposed as nodes in the hierarchy. Further, each node in the hierarchy may be represented using an XML (extensible markup language) metadata stream. A metadata hook may be provided at the node level of the hierarchy to allow access to metadata at each node level.

At step 606, the API enables the clip to be referred to anywhere on a network independent of underlying storage. Such capabilities may be enabled by the API communication with a server daemon/service on the server. Thus, the API may provide an ability to read and write the clip information and frame data directly to/from native storage. It should also be noted that the proprietary file system may not be used. In this regard, the user is unaware of the structure or type of underlying storage system but merely sees the hierarchical system that does not indicate the type of file system used.

FIG. 7 illustrates the logical flow for transferring data in the background in accordance with one or more embodiments of the invention. At step 700, a background I/O (BIO) plug-in is installed on a background server that controls or is coupled to a file system (proprietary or otherwise). At step 702, the BIO manager receives a request to transfer data (e.g., from an IFFFS application or an application that is hosting a proprietary file system). At step 704, the BIO manager communicates with the BIO plug-in to coordinate the transfer of data in the background. At step 706, the BIO plug-in transfers data from the file system to one or more servers in the background pursuant to the guidance/instructions of the BIO manager. In addition, the transfer of data at step 706 may occur in the background to a disc or other temporary storage medium.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A computer implemented system for sharing audio/video clips on a network comprising:
(a) a clip comprising a collection of formatted frames;
(b) a proprietary file system configured to store the clip;
(c) a server configured to host the proprietary file system;
(d) a lightweight application programming interface (API) that enables communication with the server, wherein:
(i) the API exposes clip information for clips on the proprietary file system through a tree-like hierarchy;
(ii) the API enables a clip to be referred to anywhere on a network independent of underlying storage.

2. The system of claim 1 wherein the API provides an ability to read and write the clip information and frame data directly to/from native storage.

3. The system of claim 1 wherein the lightweight API comprises a simple unified interface to a small set of utility functions.

4. The system of claim 1 further comprising a protocol used to enable communication across a network for remote communication.

5. The system of claim 1 wherein the API is configured to communicate with a server daemon/service on the server.

6. The system of claim 1 wherein storage structures on the proprietary file system are exposed as nodes in the tree-like hierarchy.

7. The system of claim 6 wherein a node in the hierarchy is represented using an XML (extensible markup language) metadata stream.

8. The system of claim 6 wherein a metadata hook is provided at the node level of the hierarchy to allow access to metadata at each node level.

9. A computer implemented system for a background transferring of data comprising:
(a) a file system;
(b) a background server communicatively coupled to the file system;
(c) a background input/output (I/O) plug-in installed in the background server, wherein the background I/O plug-in is configured to:
(i) communicate with a background I/O manager;
(ii) transfer data from the file system to one or more servers in the background;
(d) the background I/O manager configured to:
(i) receive a request to transfer data;
(ii) communicate with the background I/O plug-in to coordinate the data transfer in the background.

10. The system of claim 9, wherein the background I/O manager receives the request from an application hosting a proprietary file system.

11. The system of claim 9, wherein the background I/O plug-in is configured to transfer the data from the file system to a disc.

12. A computer-implemented method for sharing audio/video clips on a network comprising:
(a) storing a clip that comprises a collection of formatted frames on a proprietary file system hosted by a server;
(b) enabling communication with the server through a lightweight application programming interface (API), wherein:
(i) the API exposes clip information for clips on the proprietary file system through a tree-like hierarchy;
(ii) the API enables a clip to be referred to anywhere on a network independent of underlying storage.

13. The method of claim 12 wherein the API provides an ability to read and write the clip information and frame data directly to/from native storage.

14. The method of claim 12 wherein the lightweight API comprises a simple unified interface to a small set of utility functions.

15. The method of claim 12 wherein the API further utilizes a protocol to enable communication across the network for remote communication.

16. The method of claim 12 wherein the API is configured to communicate with a server daemon/service on the server.

17. The method of claim 12 wherein storage structures on the proprietary file system are exposed as nodes in the tree-like hierarchy.

18. The method of claim 17 wherein a node in the hierarchy is represented using an XML (extensible markup language) metadata stream.

19. The method of claim 17 wherein a metadata hook is provided at the node level of the hierarchy to allow access to metadata at each node level.

20. A computer implemented method for transferring data in the background comprising:
(a) installing a background input/output (I/O) plug-in on a background server that is communicatively coupled to a file system;
(b) receiving a request, in a background I/O manager, to transfer data;
(c) the background I/O manager communicating with the background I/O plug-in to coordinate the transfer of data in the background; and
(d) the background I/O plug-in transferring data from the file system to one or more servers in the background pursuant to the communication from the background I/O manager.

21. The method of claim 20, wherein the background I/O manager receives the request from an application hosting a proprietary file system.

22. The method of claim 20, wherein the background I/O plug-in is configured to transfer the data from the file system to a disc.
